(19) United States
(12) Patent Application Publication
(10) Pub. No.: US 2022/0398061 A1
(43) Pub. Date: Dec. 15, 2022

(54) MEDIA DISPLAY SYSTEM AND METHODS

(71) Applicant: Nandish Patel, Langhorne, PA (US)

(72) Inventor: Nandish Patel, Langhorne, PA (US)

(21) Appl. No.: 17/838,569

(22) Filed: Jun. 13, 2022

Related U.S. Application Data
(60) Provisional application No. 63/210,006, filed on Jun. 12, 2021.

(51) Int. Cl. G06F 3/14

(52) U.S. Cl. CPC G06F 3/1454

(57) ABSTRACT

A media display system comprises a control device, a network, a server communicatively connected to the control device via the network, a database communicatively connected to the server via the network and at least one display device communicatively connected to the server via the network. A media display method comprises providing a media display system, uploading at least one media file from the control device to the server, storing the at least one media file on the database, downloading the at least one media file to the at least one display device from the database via the server, storing the at least one media file in a memory of the at least one display device, selecting a media file for display from the at least one media file based on a user input on the control device, and displaying the selected media file on the at least one display device.

### CROSS-REFERENCE TO RELATED APPLICATIONS

This application claims priority to U.S. provisional application No. 63/210,006 filed on Jun. 12, 2021, incorporated herein by reference in its entirety.

### BACKGROUND

Traditionally, displays used by business establishments such as for example menu boards used in restaurants, point of purchase displays used in retail stores, and any other type of signage, advertising or marketing display used in a commercial setting have several limitations. Signage that is printed requires delivery of the printed materials, removal of old printed materials from building walls or windows, mounting of new printed materials, and manpower for completing the task. This has several disadvantages, including pollution related to required delivery of physical printed materials and printing of the materials themselves, disposal of old printed materials, costs related to hiring of employees to remove and mount printed materials, damage related to applying adhesive to walls and windows, and the human element which often leads to signs being placed crooked, in the wrong location, at the wrong time, or not being placed at all in the event of delays in printing, shipping, or human error. Further, printed signage cannot practically be updated in real time throughout the day.

Another option that eliminates many of the obstacles related to printed materials is digital signage. However, current digital signage technology typically requires cumbersome hardware setups at the location of each display or set of displays. So, for example, a franchise owner that wants to use similar display content at several stores in a particular geographical region would typically have to include a hardware setup at each store (in some cases utilizing hardware for each display at a store) and control the display content locally at the store level via the hardware at that store. Further, the content has to be loaded in the store hardware and does not typically have functionality that takes advantage of data that may be available from the higher-level franchisor or franchise owner level, or data that may be available from other sources on a more macro level.

Improved media display technology would be useful in many areas such as commercial point of purchase marketing, building signage, entertainment, education, retail sales, and advertising. Digital signage and menu display systems that do not suffer from high complexity or the additional cost of unreliable and expensive hardware would represent an improvement in the art and would eliminate issues that come with hardcopy display systems, which are time intensive to update and create waste of unused display signage. An improved media display systems and method is described below.

### SUMMARY

Some embodiments of the invention disclosed herein are set forth below, and any combination of these embodiments (or portions thereof) may be made to define another embodiment.

In one aspect, a media display system comprises a control device, a network, a server communicatively connected to the control device via the network, a database communicatively connected to the server via the network, and at least one display device communicatively connected to the server via the network.

In one embodiment, the control device includes a network device configured to communicate with the server over the network. In one embodiment, the network device of the control device is configured to upload a media file to the server. In one embodiment, the server is configured to store the media file on the database. In one embodiment, the server and database are cloud based. In one embodiment, the at least one display device includes a memory configured to store a media file, and a network device configured to communicate with the server of the network. In one embodiment, the network device of the at least one display device is configured to download the media file from the server. In one embodiment, the downloaded media file is stored in the memory.

In one embodiment, the media file includes a user ID, a store ID, a sub-store ID, a display ID, and a media ID. In one embodiment, the media file includes a variable having a value set based on external input. In one embodiment, the external input comprises at least one of weather data, temperature data, user data, GPS data, population data, order history data, traffic data, supply chain data, promotional data and sales data. In one embodiment, the external input is received from a sensor configured proximate to the at least one display device. In one embodiment, the external input determines which display device receives the media file. In one embodiment, the external input determines which display device has volume on and which display device has volume off. In one embodiment, the external input determines which display device is on and which display device is off. In one embodiment, the external input determines a language associated with the media file. In one embodiment, the external input determines whether to loop or skip a media file.

In one embodiment, the variable is configured to modify an alphanumeric value generated on the at least one display device. In one embodiment, the alphanumeric value comprises a price of a product or service. In one embodiment, the value set is based on real time external input. In one embodiment, the at least one display device is one of a plurality of display devices.

In one embodiment, the system further comprises a non-transitory computer-readable medium with instructions stored thereon, that when executed by a processor, performs steps comprising uploading at least one media file from the control device to the server, storing the at least one media file on the database, downloading the at least one media file to the at least one display device from the database via the server, storing the at least one media file in a memory of the at least one display device, selecting a media file for display from the at least one media file based on a user input on the control device, and displaying the selected media file on the at least one display device. In one embodiment, the at least one display device comprises a digital menu board.

In another aspect, a media display method comprises providing a media display system including a control device, a network, a server communicatively connected to the control device via the network, a database communicatively connected to the server via the network, and at least one display device communicatively connected to the server via the network, uploading at least one media file from the control device to the server, storing the at least one media file on the database, downloading the at least one media file to the at least one display device from the database via the server, storing the at least one media file in a memory of the at least one display device, selecting a media file for display from the at least one media file based on a user input on the control device, and displaying the selected media file on the at least one display device.

In one embodiment, the at least one display device comprises a digital menu board. In one embodiment, the user input of the selection is input via a user interface. In one embodiment, the method further comprises synchronizing the at least one media file stored in the memory of the display device to the at least one media file stored on the database. In one embodiment, the media file includes a user ID, a store ID, a sub-store ID, a display ID, and a media ID. In one embodiment, the media file includes a variable having a value set based on external input.

In one embodiment, the external input comprises at least one of weather data, temperature data, user data, GPS data, population data, order history data, traffic data, supply chain data, promotional data and sales data. In one embodiment, the external input is received from a sensor configured proximate to the at least one display device. In one embodiment, the external input determines which display device receives the media file. In one embodiment, the external input determines which display device has volume on and which display device has volume off. In one embodiment, the external input determines which display device is on and which display device is off. In one embodiment, the external input determines a language associated with the media file. In one embodiment, the external input determines whether to loop or skip a media file.

In one embodiment, the variable is configured to modify an alphanumeric value generated on the at least one display device. In one embodiment, the alphanumeric value comprises a price of a product or service. In one embodiment, the value set is based on real time external input. In one embodiment, the at least one display device is one of a plurality of display devices. In one embodiment, the method further comprises selectively displaying a selected media file on subset of the at least one display device.

In another aspect, a non-transitory computer readable medium, with instructions stored thereon, that when executed by a processor of a computing system, cause the computing system to perform a media display method, comprises uploading at least one media file from a control device to the server, storing at least one media file on a database, downloading the at least one media file to at least one display device from the database via the server, storing the at least one media file in a memory of the at least one display device, selecting a media file for display from the at least one media file based on a user input on the control device, and displaying the selected media file on the at least one display device.

In another aspect, a media display method includes the steps of uploading a plurality of media files to a server communicatively connected to a first and second plurality of displays; defining a plurality of rules that are satisfied based on an external input; selecting a first of the plurality of media files based on a first of the plurality of rules being satisfied for display on the first plurality of displays; and selecting a second of the plurality of media files based on a second of the plurality of rules being satisfied for display on the second plurality of displays. In one embodiment, the external input comprises at least one of weather data, temperature data, user data, GPS data, population data, order history data, traffic data, supply chain data, promotional data and sales data. In one embodiment, the external input is received from a sensor configured proximate to the at least one display device. In one embodiment, the external input determines which display device receives the media file. In one embodiment, the external input determines whether to loop or skip a media file. In one embodiment, a variable associated with the media file is configured to modify an alphanumeric value generated on the at least one display device based on the external input. In one embodiment, the alphanumeric value comprises a price of a product or service. In one embodiment, the value set is based on real time external input.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a block diagram depicting an exemplary media display system in accordance with some embodiments.

FIG. 2 is a block diagram depicting further details of the exemplary media display system in accordance with some embodiments.

FIG. 3 is a block diagram depicting an exemplary computing system utilized by the exemplary media display system in accordance with some embodiments.

FIG. 4 is a flow-chart depicting an exemplary media display method in accordance with some embodiments.

FIG. 5 depicts an exemplary user interface of the media display system in accordance with some embodiments.

FIG. 6 depicts another exemplary user interface of the media display system in accordance with some embodiments.

FIG. 7 depicts another exemplary user interface of the media display system in accordance with some embodiments.

FIG. 8 depicts another exemplary user interface of the media display system in accordance with some embodiments.

FIG. 9 is a flow chart showing an exemplary working model of a control application to control the media display system in accordance with some embodiments.

FIG. 10 is a flow chart showing another exemplary working model of a control application to control the media display system in accordance with some embodiments.

### DETAILED DESCRIPTION

It is to be understood that the figures and descriptions of the present invention have been simplified to illustrate elements that are relevant for a clearer comprehension of the present invention, while eliminating, for the purpose of clarity, many other elements found in systems and methods of media display. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a media display system and related methods.

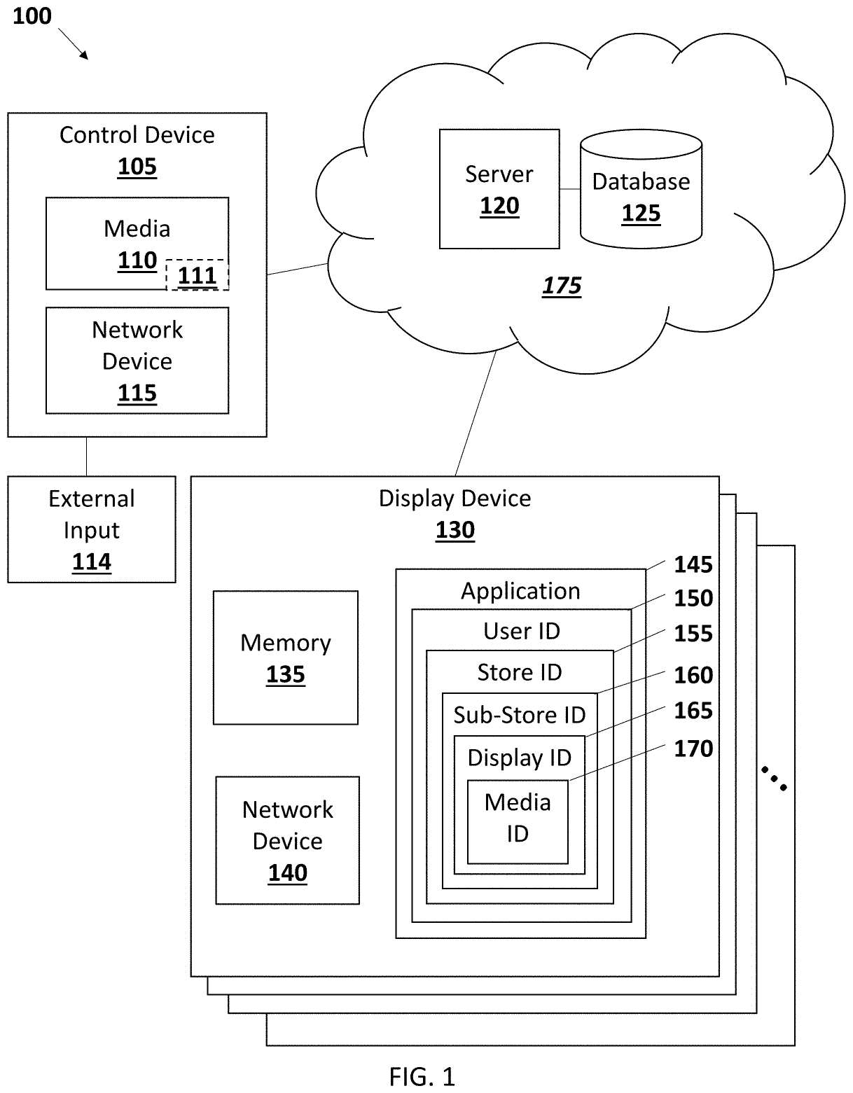

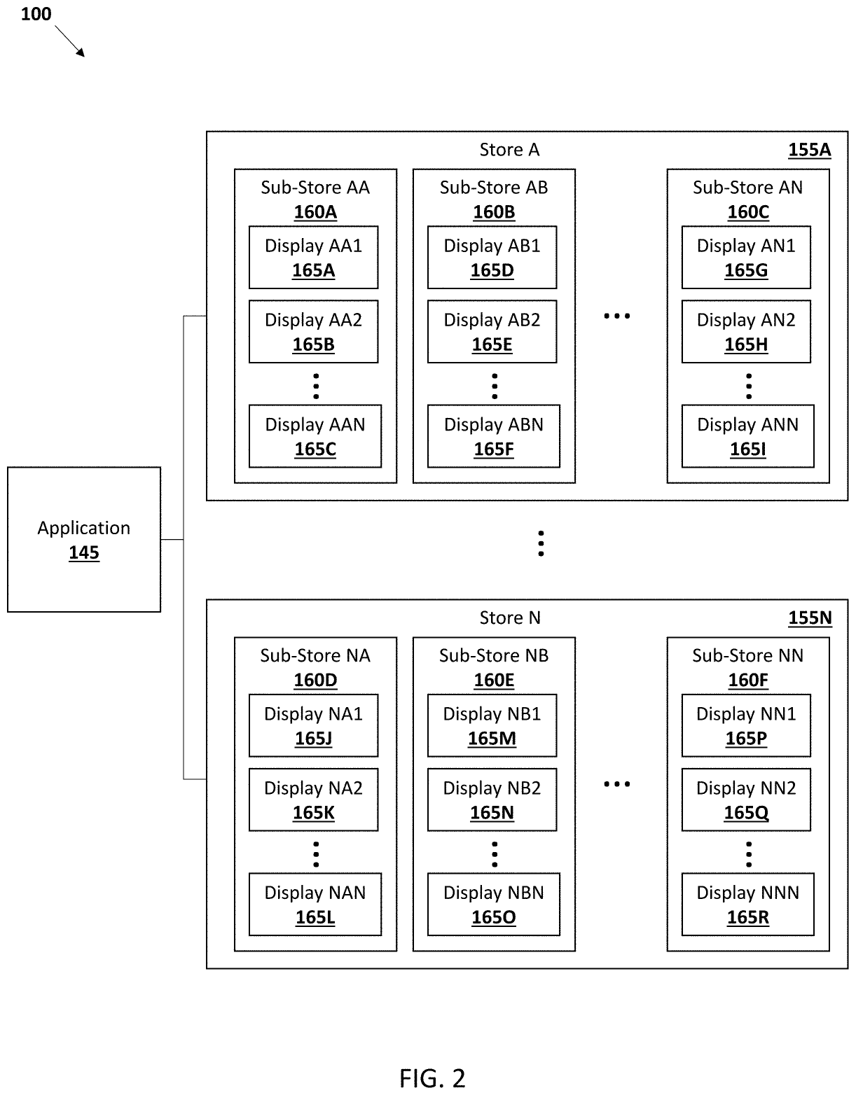

FIG. 1 is a block diagram depicting an exemplary media display system 100, and FIG. 2 is a block diagram depicting further details of the exemplary media display system 100 in accordance with some embodiments. The media display system 100 can include a control device 105, a network 175, a server 120 communicatively connected to the control device 105 via the network 175, a database 125 communicatively connected to the server 120 via the network 175, and at least one display device 130 communicatively connected to the server 120 via the network 175. In some embodiments, the at least one display device can comprise a projector, an LCD display, a CRT display, a LED display, a Plasma display, an e-ink display, and any other suitable display or combination thereof.

In some embodiments, the control device 105 includes a network device 115 configured to communicate with the server 120 over the network 175. The network device 115 can be a wireless network device in some examples, and a wired network device in other examples. In some embodiments, the network device 115 of the control device 105 is configured to upload a media file 110 to the server 120. The media file 110 can be any suitable media file type including, for example, png, jpg, gif, mp3, and mp4.

In some embodiments, the server 120 is configured to store the media file 110 on the database 125. In some embodiments, the server 120 and database 120 are cloud based, and thus positioned remotely relative to the control device 105 and the display device 130. In some embodiments, the at least one display device 130 includes a memory 135 configured to store a media file 110, and a network device 140 configured to communicate with the server 120 of the network 175. In some embodiments, the network device 140 of the at least one display device 130 is configured to download the media file 110 from the server 120. In some embodiments, the downloaded media file 110 is stored in the memory 135. The memory 135 can be any suitable memory type including, for example, cache, RAM, ROM, EPROM, EEPROM, flash memory or other solid state memory technology, CD-ROM, DVD, or other optical storage, magnetic cassettes, magnetic tape, magnetic disk storage or other magnetic storage devices.

In some embodiments, the media file 110 includes a user ID 150, a store ID 155, a sub-store ID 160, a display ID 165, and a media ID 170. The ID tags (150, 155, 160, 165, 170) can be used by an application 145 to direct a selected media file 110 to a subset of the at least one display device 130. In some embodiments, the media file 110 further includes a variable 111 that can be set by the user via the control device 105. In one embodiment, the variable 111 can be used to change an alphanumeric value such as a price displayed in the media file. In one embodiment, the variable 111 can changed based on the external input 114. More generally, external input 114 can be provided by a sensor, module, computer or other source of data that in some embodiments includes at least one of weather data, temperature data, user data, GPS data, population data, order history data, traffic data, supply chain data, promotional data and sales data. In some embodiments, the sales data is retrieved from a point-of-sales (POS) system communicatively connected to the media display system 100. In some embodiments, the external input 114 is received from a sensor configured proximate to the display device 130 or more generally at the individual store level.

In one embodiment, the control device 105 can include a set of rules and parameters set by a user (e.g., owner or general manager) for selecting certain media files to play based on the external input 114 meeting a set threshold or falling within a parameter. So, for example, if a franchise owner wants to drive sales of certain items based on local temperatures at each store, the control device 105 can set a rule to select a media file associated with promoting hot drinks on the menu board once the external input 114 indicates the temperature drops below a set threshold (e.g. 40 degrees) at local stores. Advantageously, since the media file would already be in the system library, the system automates selection of that particular media file in real time based on the temperature data for each store or subset of stores and the franchise owner can control marketing well in advance via the system in an automated and on-demand fashion. Or for example, if the price of the item displayed in the media file should be lower on a certain day or time, or based on external input 114, the control device 105 can set the variable 111 to change and reflect the new price on the menu board. The system can allow high-level users to manipulate what is displayed on the screen based on a macro marketing strategy and preset parameters (for example set by a franchise owner or general manager), yet the implementation at the micro/store level can be selective depending on external inputs specific to the particular location. Further examples may include (but not limited to): weather and temperature data (e.g. promote products which sell best in that weather, promoting sales ahead of an adverse weather event, or selecting media files that show weather backgrounds which match the weather of the store location), user data (e.g. promote products that match user preferences or preferences of people related to the user, for example via social media data), GPS data (e.g. promote products based on the user's travel history), population data (e.g. promote products popular in a sub-region of stores, or those that are emerging as popular in a different region), order history data (e.g. promote products based on ordering patterns), traffic data (e.g. promote products based on traffic and for example encouraging drive-through purchasing vs. in-store purchasing), supply chain data (e.g. promoting products and adjusting pricing based on changes in supply prices, surpluses or shortages), promotional data (e.g. promoting products based on franchisor or manufacturer promotions) and sales data (e.g. promoting products based on sales trends).

In some embodiments, the external input determines which display device 130 receives the media file 110. In some embodiments, the external input determines which display device 130 has volume on and which display device 130 has volume off. In some embodiments, the external input determines which display device 130 is on and which display device is off 130. In some embodiments, the external input determines a language associated with the media file 110. In some embodiments, the external input determines whether to loop or skip a media file 110.

In some embodiments, the variable is configured to modify an alphanumeric value generated on the at least one display device 130. In some embodiments, the alphanumeric value comprises a price of a product or service. In some embodiments, the value set is based on real time external input. In some embodiments, the at least one display device 130 is one of a plurality of display devices.

In some embodiments, the system 100 further comprises a non-transitory computer-readable medium with instructions stored thereon, that when executed by a processor, performs steps comprising uploading at least one media file 110 from the control device 105 to the server 120, storing the at least one media file 110 on the database 125, downloading the at least one media file 110 to the at least one display device 130 from the database 125 via the server 120, storing the at least one media file 110 in a memory 135 of the at least one display device 130, selecting a media file 110 for display from the at least one media 110 file based on a user input on the control device 105, and displaying the selected media file 110 on the at least one display device 130. In some embodiments, the at least one display device 130 comprises a digital menu board.

FIG. 2 shows an example of an application 145 configured to utilize the media display system 100. The application 145 can comprise a multi-layer structure of ID tags including a user ID 150, a store ID 155, a sub-store ID 160, a display ID 165 and a media ID 170. These ID tags can be utilized by the application to select a chosen media file 110 to be displayed on a chosen display device 130. In some embodiments, the tag ID structure can be configured where each of a plurality of display IDs 165A-R are assigned to one of a plurality of sub-store IDs 160A-F. In some embodiments, each of the plurality of sub-store IDs 160A-F are assigned to one of a plurality of store IDs 155A-N. The application 145 can be used to selectively display a media file 110 on one or more of a plurality of display devices 130 based on the ID tags (155, 160, 165). In some embodiments, the database 125 can be an XML database configured to store a media file 110 with associated ID tags (155, 160, 165).

In some embodiments, artificial intelligence (AI) and/or machine learning (ML) can be utilized by the system 100. In some embodiments, AI and/or ML can identify sales figures based on information from a POS system and modify an alphanumeric value generated on a display device 130, such as prices on a menu board, for example.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

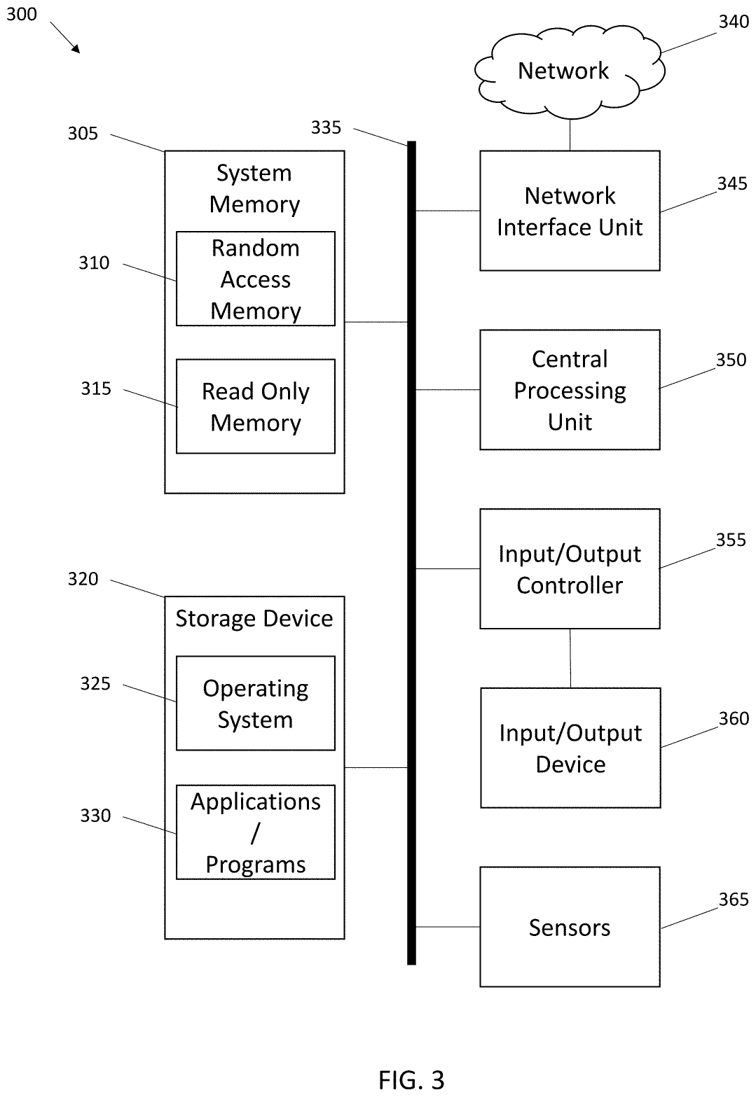

FIG. 3 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 3 depicts an illustrative computer architecture for a computer 300 for practicing the various embodiments of the invention. The computer architecture shown in FIG. 3 illustrates a conventional personal computer, including a central processing unit 350 (“CPU”), a system memory 305, including a random-access memory 310 (“RAM”) and a read-only memory (“ROM”) 315, and a system bus 335 that couples the system memory 305 to the CPU 350. A basic input/output system containing the basic routines that help to transfer information between elements within the computer, such as during startup, is stored in the ROM 315. The computer 300 further includes a storage device 320 for storing an operating system 325, application/program 330, and data.

The storage device 320 is connected to the CPU 350 through a storage controller (not shown) connected to the bus 335. The storage device 320 and its associated computer-readable media, provide non-volatile storage for the computer 300. Although the description of computer-readable media contained herein refers to a storage device, such as a hard disk or CD-ROM drive, it should be appreciated by those skilled in the art that computer-readable media can be any available media that can be accessed by the computer 300.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 300 may operate in a networked environment using logical connections to remote computers through a network 340, such as TCP/IP network such as the Internet or an intranet. The computer 300 may connect to the network 340 through a network interface unit 345 connected to the bus 335. It should be appreciated that the network interface unit 345 may also be utilized to connect to other types of networks and remote computer systems.

The computer 300 may also include an input/output controller 355 for receiving and processing input from a number of input/output devices 360, including a keyboard, a mouse, a touchscreen, a camera, a microphone, a controller, a joystick, or other type of input device. Similarly, the input/output controller 355 may provide output to a display screen, a printer, a speaker, or other type of output device. The computer 300 can connect to the input/output device 360 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 320 and RAM 310 of the computer 300, including an operating system 325 suitable for controlling the operation of a networked computer. The storage device 320 and RAM 310 may also store one or more applications/programs 330. In particular, the storage device 320 and RAM 310 may store an application/program 330 for providing a variety of functionalities to a user. For instance, the application/program 330 may comprise many types of programs such as a word processing application, a spreadsheet application, a desktop publishing application, a database application, a gaming application, internet browsing application, electronic mail application, messaging application, and the like. According to an embodiment of the present invention, the application/program 330 comprises a multiple functionality software application for providing word processing functionality, slide presentation functionality, spreadsheet functionality, database functionality and the like.

The computer 300 in some embodiments can include a variety of sensors 365 for monitoring the environment surrounding and the environment internal to the computer 300. These sensors 365 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

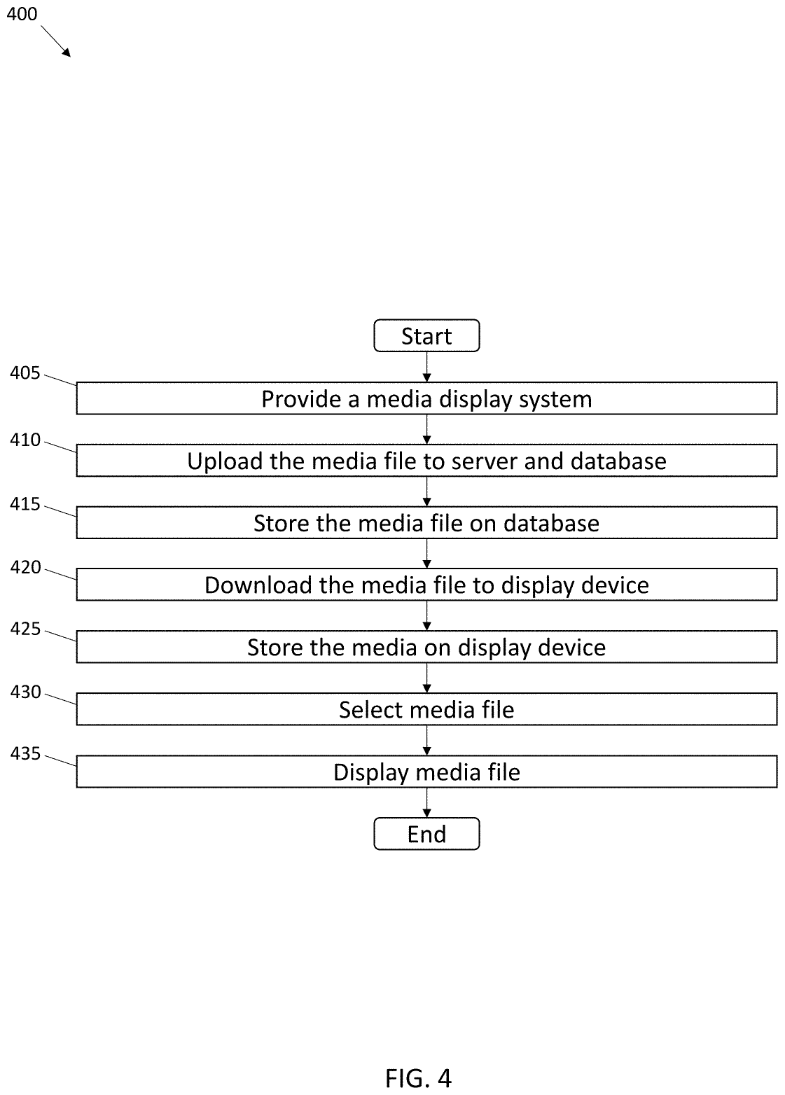

FIG. 4 is a flow-chart showing an exemplary media display method 400. The method 400 starts at operation 405, where a media display system 100 is provided. The media display system 100 can include a control device 105, a network 175, a server 120 communicatively connected to the control device 105 via the network 175, a database 125 communicatively connected to the server 120 via the network 175, and at least one display device 130 communicatively connected to the server 120 via the network 175.

At Operation 410, at least one media file 110 is uploaded from the control device 105 to the server 120. At Operation 415, the at least one media file 110 is stored on the database 125. At Operation 420, the at least one media file 110 is downloaded to the at least one display device 130 from the database 125 via the server 120. At Operation 425, the at least one media file 110 is stored in a memory 135 of the at least one display device 130. At Operation 430, a media file 110 is selected for display from the at least one media file 110 based on a user input on the control device 105. In some embodiments, the user input of the selection is input via a user interface. The method 400 ends at Operation 435, where the selected media file 110 is displayed on the at least one display device 130. In some embodiments, the at least one display device comprises a digital menu board.

In some embodiments, the method 400 further comprises synchronizing the at least one media file 110 stored in the memory 135 of the display device 130 to the at least one media file 110 stored on the database 125. In some embodiments, the method 400 further comprises selectively displaying a selected media file 110 on subset of the at least one display device 130.

In some embodiments, the media file 110 includes a user ID 150, a store ID 155, a sub-store ID 160, a display ID 165, and a media ID 170. In some embodiments, the media file 110 includes a variable having a value set based on external input. In some embodiments, the external input comprises at least one of weather data, temperature data, user data, GPS data, population data, order history data, traffic data, supply chain data, promotional data and sales data. In some embodiments, the sales data is retrieved from a point-of-sales (POS) system communicatively connected to the media display system 100. In some embodiments, the external input is received from a sensor configured proximate to the at least one display device 130. In some embodiments, the external input determines which display device 130 receives the media file 110. In some embodiments, the external input determines which display device 130 has volume on and which display device 130 has volume off. In some embodiments, the external input determines which display device 130 is on and which display device is off 130. In some embodiments, the external input determines a language associated with the media file 110. In some embodiments, the external input determines whether to loop or skip a media file 110.

In some embodiments, the variable is configured to modify an alphanumeric value generated on the at least one display device 130. In some embodiments, the alphanumeric value comprises a price of a product or service. In some embodiments, the value set is based on real time external input. In some embodiments, the at least one display device 130 is one of a plurality of display devices 130.

In some embodiments, two-factor or multi-factor authentication is required to publish media. In some embodiments, the media can be played on a plurality of screens simultaneously and/or synchronized. In some embodiments, the location and/or model of the display device 130 is automatically detected. In some embodiments, AI can track footfall proximate to a display device 130, and can further identify male or female if there is a camera associated with the display device 130.

In some embodiments, API integration can be used to directly show a menu from a POS system and design a menu template based on the display device 130 resolution. In some embodiments, AI can track each transaction item-by-item as per the weather and will maintain the record in a database. In some embodiments, multi-level approval for any submission requests can be utilized. In some embodiments, geofencing can be utilized to define and set media based on the territory. In some embodiments, an alert can be displayed when there is no internet connection. In some embodiments, the media is automatically shaped to fit the display device 130. In some embodiments, a whiteboard can be published on any display device 130 which allows a user to draw, type, drag and drop media. In some embodiments, a human body temperature can be detected when proximate to the display device 130. In some embodiments, the display device 130 can comprise any number of displays, any shape, and any size. In some embodiments, multivendor media management with a fully customizable plan and billing feature can be provided that allows any vendor to choose any geography, number of screens, time slot, etc.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples, therefore, specifically point out exemplary embodiments of the present invention, and are not to be construed as limiting in any way the remainder of the disclosure.

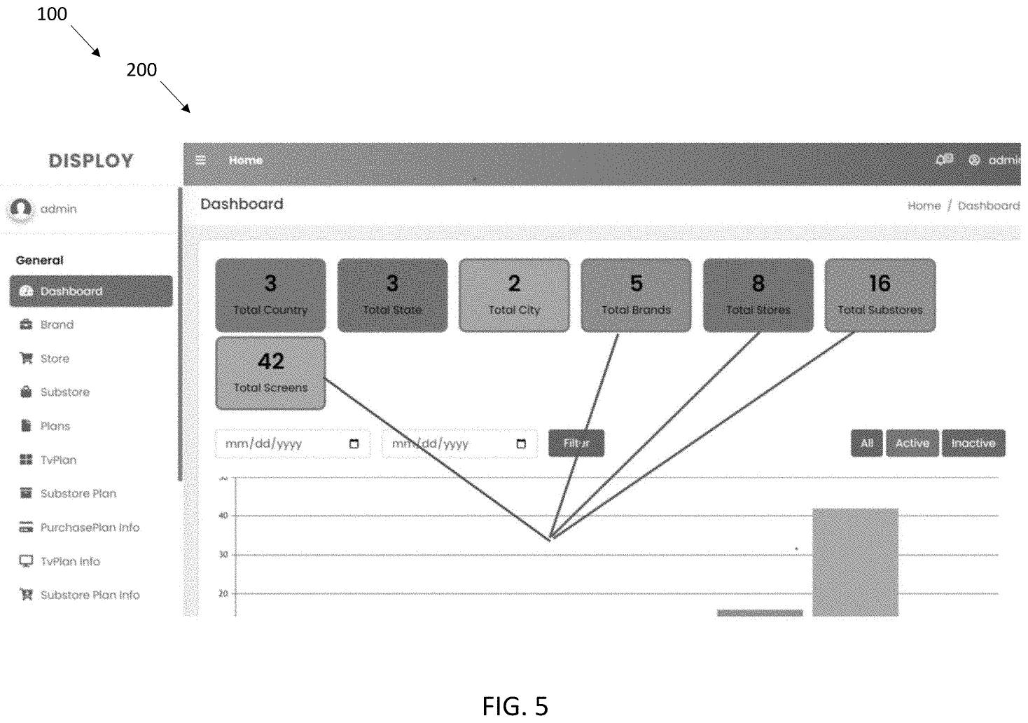

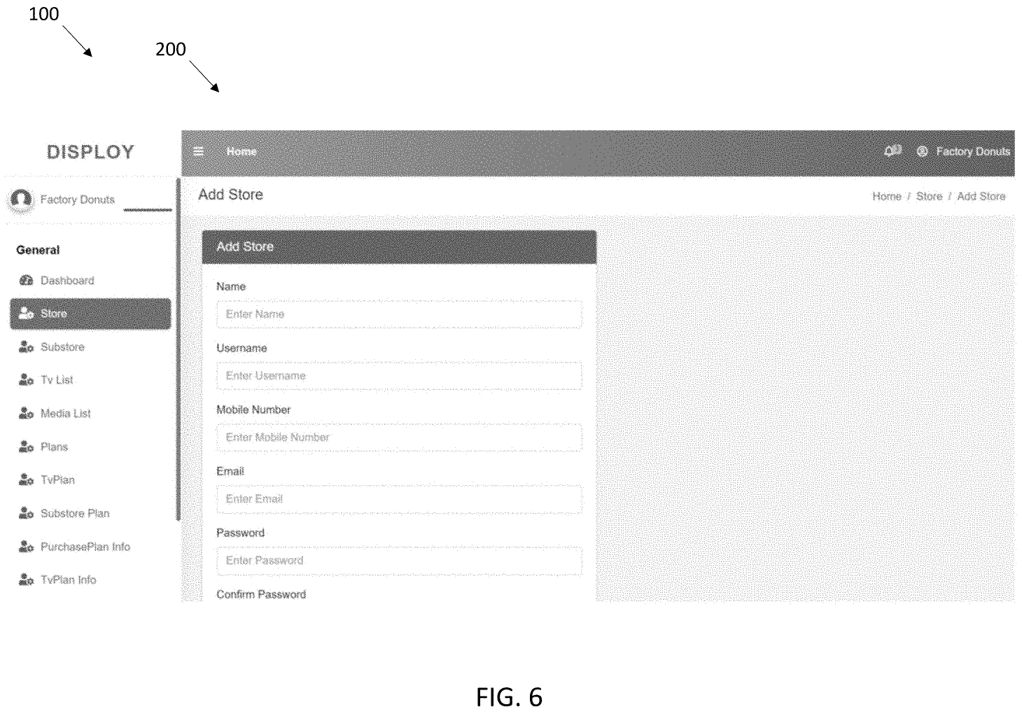

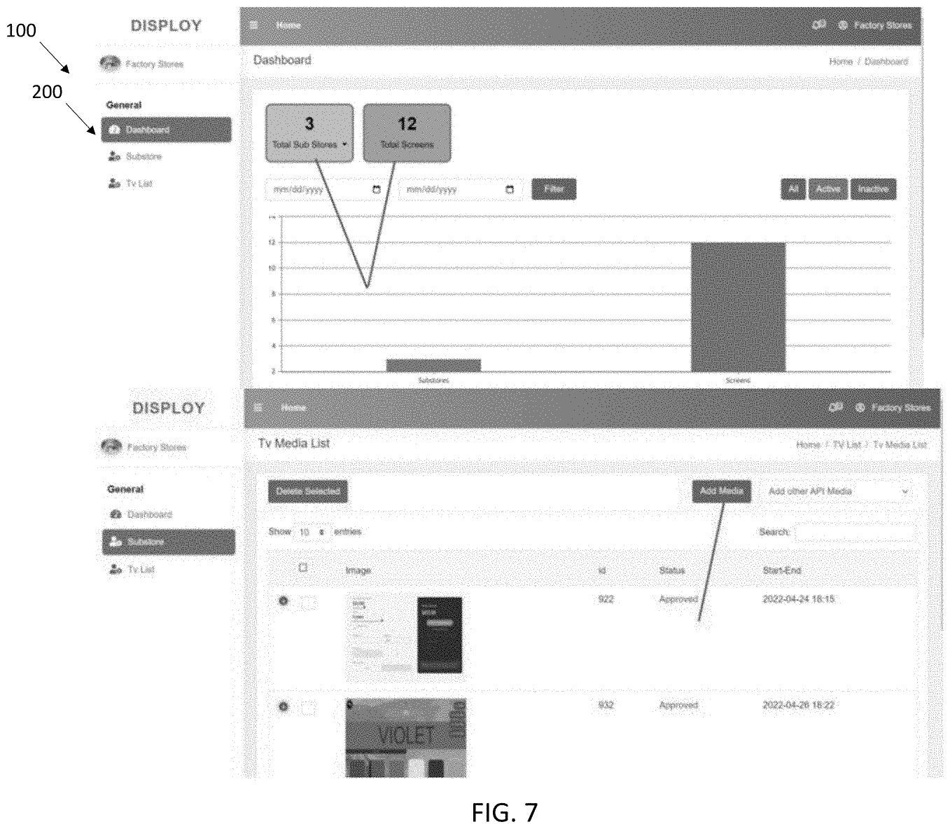

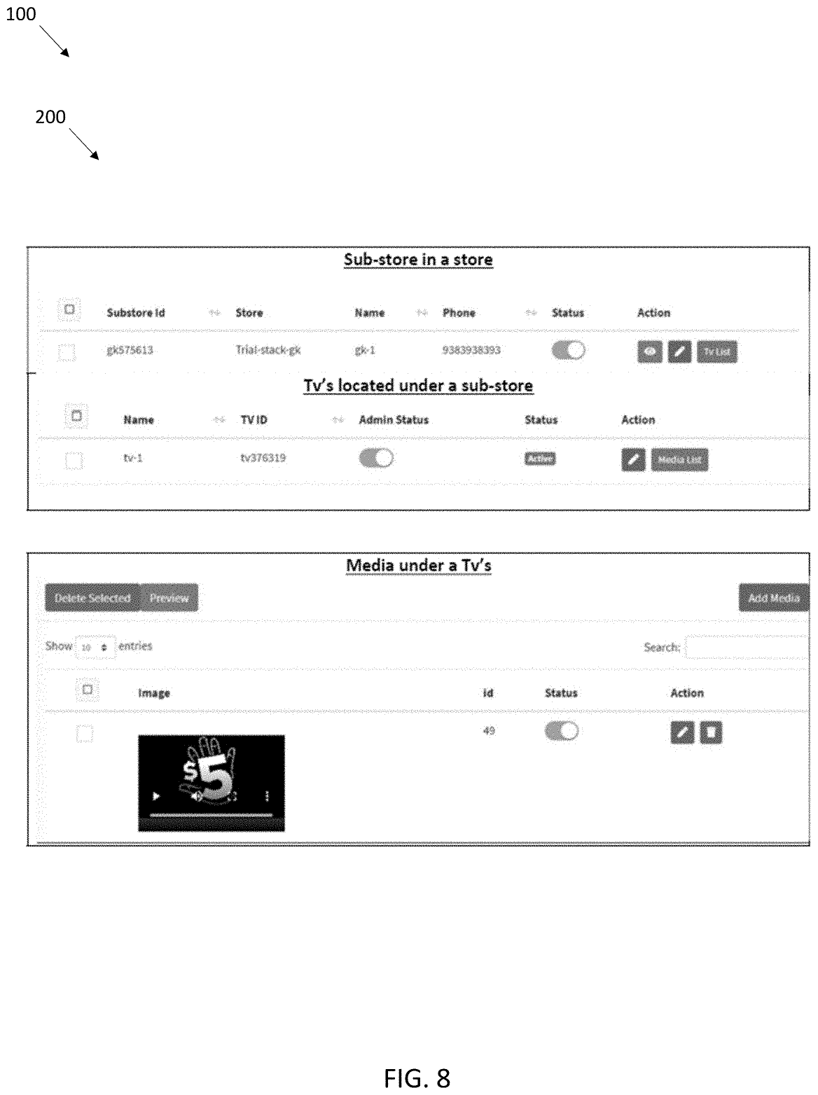

FIGS. 5, 6, 7 and 8 show screenshots of an exemplary user interface (UI) 200 of an application 145 for utilizing the system 100. FIG. 5 shows an example of an administrator dashboard. Via this dashboard a user can add/delete/sync store, sub-store and TV display identifiers (155, 160, 165). FIG. 6 shows an example of an administrator panel where a user can add store information into the application 145. A similar panel can also be used to gather sub-store information. Both the store and sub-store will be assigned a unique ID (155, 160) when stored in the database 125. FIG. 7 shows an example of a store portal where a user can add media only and can further see the number of sub-stores and screens falling under their account. In some embodiments, as soon as a brand user can approve the media content, the media content can be published into the respective retriever. In some embodiments, both the store and sub-store get a unique ID (155, 160) stored into the database 125. FIG. 8 shows an example of the UI 200 displaying information and control operations for a store ID 155, a sub-store ID 160, a display ID 165, and a media ID 170 for a media file 110. In some embodiments, the UI 200 can include further functionalities such as an ability to schedule the media content to be published at a specific time, the ability to retrieve and display media from a third-party application, the ability to show a weather report in real time and relay that weather report to the server 120, and other suitable abilities, for example.

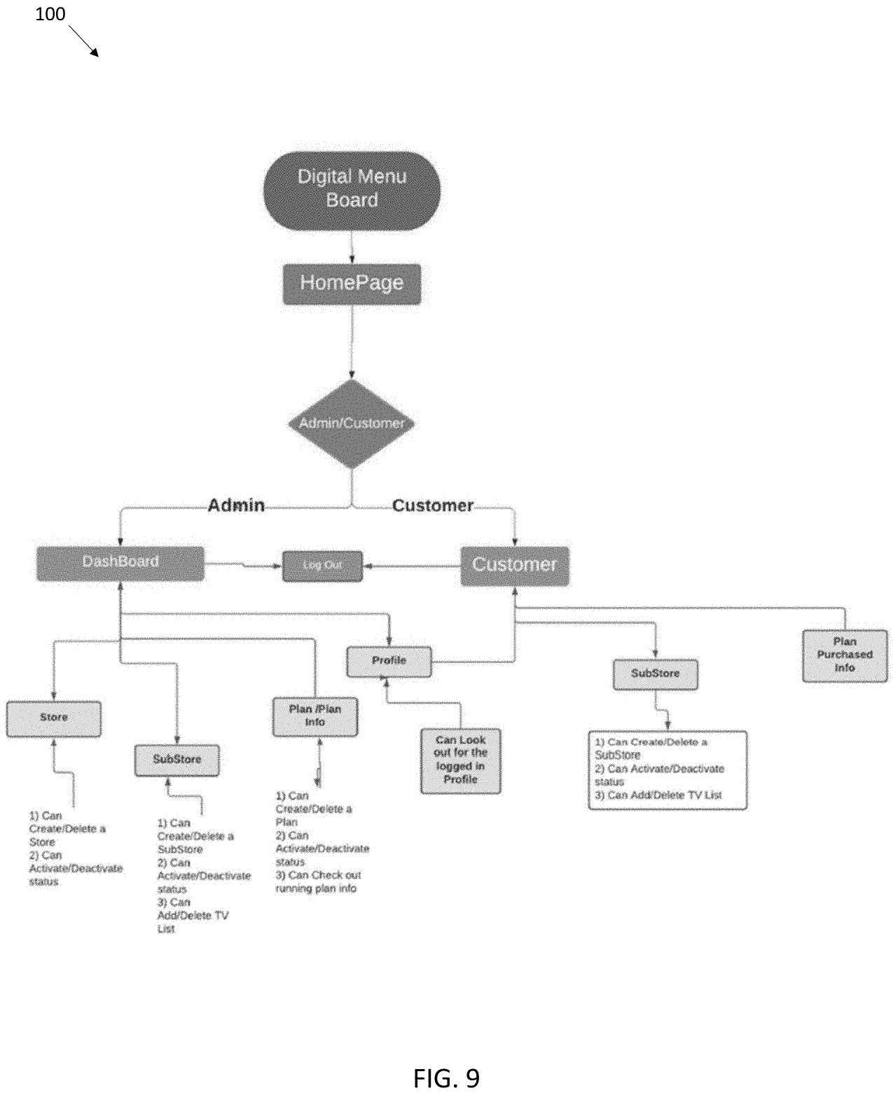

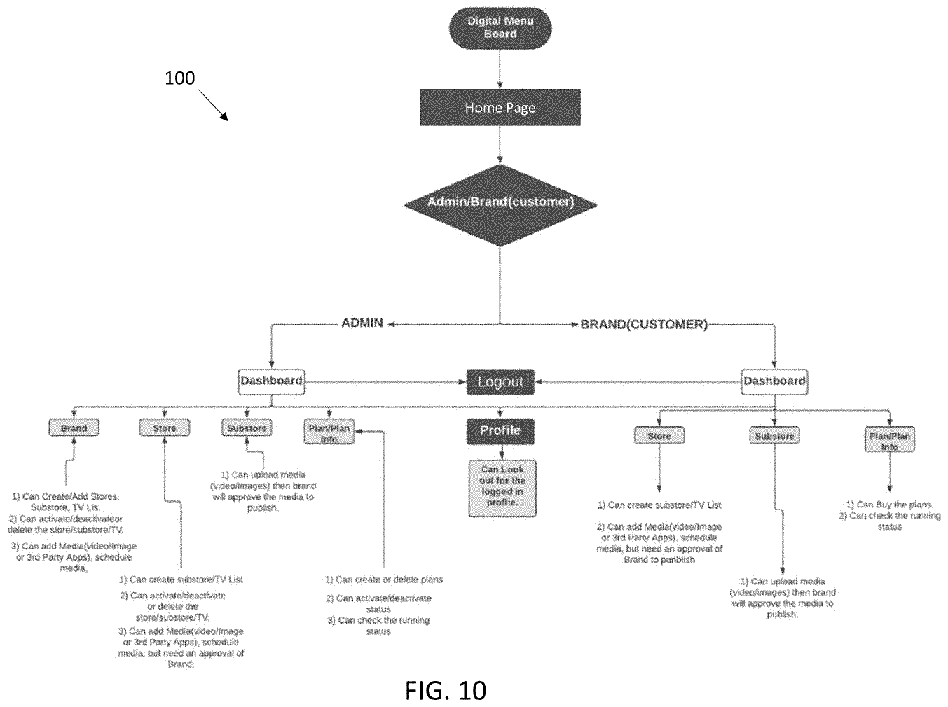

FIGS. 9 and 10 are flow charts showing exemplary working models of the application 145. In the examples shown, the application is utilized to perform the practical application of control digital menu boards. The application initiates to a homepage, where a decision is made by a user to proceed as an administrator or a customer and/or brand.

If the user proceeds as a customer or brand, a customer dashboard page is shown. This customer dashboard page can allow for operations to be performed related to a profile, a store, a sub-store, a plan purchased info and/or a plan/plan info. Under the store and/or sub-store operations, the user can create/delete a sub-store, activate/deactivate a status, add/schedule media and seek approval from the brand to publish the media, and can add/delete a TV display list. Under the plan/plan info operation the user can buy the plans and can check the running status.

If the user proceeds as an administrator, an admin dashboard is shown. The admin dashboard allows for operations to be performed related to a store, a sub-store, a plan/plan info, a brand and/or a profile. Under the store operations, the user can create/delete a store, and activate/deactivate a status, can create a sub-store/tv list, can activate/deactivate or delete a store/sub-store/tv, add/schedule media, and/or seek approval from the brand to publish the media. Under the sub-store operations, the user can create/delete a sub-store, activate/deactivate a status, add/delete a TV display list, add/schedule media and/or seek approval from the brand to publish the media. Under the plan/plan info operations, the user can create/delete a plan, activate/deactivate a status, and check out running plan info. Under the brand operations, the user can create/add stores/sub-stores/tv lists, activate/deactivate or delete a store/substore//tv, and/or add/schedule media.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1-23. (canceled)

24. A media display method, comprising:
providing a media display system including a control device, a network, a server communicatively connected to the control device via the network, a database communicatively connected to the server via the network, and at least one display device communicatively connected to the server via the network;
uploading at least one media file from the control device to the server;
storing the at least one media file on the database;
downloading the at least one media file to the at least one display device from the database via the server;
storing the at least one media file in a memory of the at least one display device;
selecting a media file for display from the at least one media file based on a user input on the control device; and
displaying the selected media file on the at least one display device.

25. The method of claim 24, wherein the at least one display device comprises a digital menu board.

26. The method of claim 24, the user input of the selection is input via a user interface.

27. The method of claim 24, further comprising synchronizing the at least one media file stored in the memory of the display device to the at least one media file stored on the database.

28. The method of claim 24, wherein the media file includes a user ID, a store ID, a sub-store ID, a display ID, and a media ID.

29. The method of claim 24, wherein the media file includes a variable having a value set based on external input.

30. The method of claim 29, wherein the external input comprises at least one of weather data, temperature data, user data, GPS data, population data, order history data, traffic data, supply chain data, promotional data and sales data.

31. The method of claim 29, wherein the external input is received from a sensor configured proximate to the at least one display device.

32. The method of claim 29, wherein the external input determines which display device receives the media file.

33. The method of claim 29, wherein the external input determines which display device has volume on and which display device has volume off.

34. The method of claim 29, wherein the external input determines which display device is on and which display device is off.

35. The method of claim 29, wherein the external input determines a language associated with the media file.

36. The method of claim 29, wherein the external input determines whether to loop or skip a media file.

37. The method of claim 29, wherein the variable is configured to modify an alphanumeric value generated on the at least one display device.

38. The method of claim 37, wherein the alphanumeric value comprises a price of a product or service.

39. The method of claim 29, wherein the value set is based on real time external input.

40. The method of claim 24, wherein the at least one display device is one of a plurality of display devices.

41. The method of claim 24, further comprising selectively displaying a selected media file on subset of the at least one display device.

42-50. (canceled)
